(19) United States
(12) Patent Application Publication
(10) Pub. No.: US 2009/0265847 A1
(43) Pub. Date: Oct. 29, 2009

(54) APPARATUS FOR ELECTRICALLY GROUNDING SAUNA USERS, INFRARED SAUNA USERS IN PARTICULAR

(76) Inventor: Roy J. Mankovitz, Montecito, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/430,342

(22) Filed: Apr. 27, 2009

Related U.S. Application Data
(60) Provisional application No. 61/048,005, filed on Apr. 25, 2008.

(51) Int. Cl. A61H 33/06

(52) U.S. Cl. 4/524

(57) ABSTRACT

Apparatus for electrically grounding users of saunas, particularly users of infrared saunas, includes an electrical conductor having a first end connected to an electrical ground and a second end coupled to a person using the sauna. The sauna may include a plurality of infrared heaters, which may operate in the far-infrared, or at least one convection heater. The second end of the electrical conductor may be coupled to a user through an electrically conductive body-worn strap, an electrically conductive pad or seat, or an electrically conductive bag enclosing at least a portion of a user's body.

### REFERENCE TO RELATED APPLICATION

This application claims priority from U.S. Provisional Patent Application Ser. No. 61/048,005, filed Apr. 25, 2008, the entire content of which is incorporated herein by reference.

### FIELD OF THE INVENTION

This invention relates generally to saunas and, in particular, to apparatus for electrically grounding users of saunas, particularly users of infrared saunas.

### BACKGROUND OF THE INVENTION

Traditional saunas of the type depicted in FIG. 1 use various types of heaters 102 to warm the air in a room. Modern saunas have thermostatically controlled electric stoves or wood stoves with chimneys. In a traditional sauna the air temperature typically runs between 169° C. to 190° F. (76° C. to 88° C.), though temperatures over 200° F. (93° C.) are sometimes encountered. The hot air 104 causes the body to heat up, and eventually results in a sweat.

An infrared sauna typically contains several infrared heaters 202, as shown in FIG. 2. Commercial products range from small, flexible one-person units to rooms with seating for several individuals. The infrared heater produces radiant energy, which is the same as the heat from the sun, only without the harmful ultraviolet rays. The radiation penetrates the body and heats through a process called conversion, instead of heating the air around the user.

The ambient temperature in an infrared sauna is much cooler than that of a traditional sauna, at around 120° C. to 140° F. (43° C. to 54° C.). The amount of sweat that results from each is comparable, though many people report that the lower temperatures in an infrared sauna allow the user to stay inside longer, resulting in longer sauna sessions and therefore more overall sweating.

Infrared sauna promoters state that infrared radiant heat is safe and beneficial, claiming that the heat penetrates more than 1.5 inches (40 mm) into the body. The argument is based on the idea that the wavelengths of far infrared waves are typically between 5.8 and 1000 micrometers. This is supposed to correspond to the vibration of the water molecule at 9.4 micrometers. Because these vibrations are similar, the infrared rays help release toxins loose from fat cells, which are then released through sweating. Proponents claim this heals and stimulates tissues, and that it is effective therapy for arthritis and tissue injuries. Because the skin is the largest organ of the body, regularly sweating in a far infrared sauna can help decrease the toxic load and contribute to better health and vitality. One of the ways that infrared sauna use is beneficial for a wide range of ailments is through the increase in circulation that it causes in the body. Increased circulation is often believed to be helpful in a variety of ways, and is generally regarded as beneficial for health.

It is also believed that the build-up of electrical charge in a human body may have detrimental side-effects. Research has indicated that stored charge may interfere with normal cellular communications and the self-regulating and self-healing mechanisms of the body, which in turn may create stress and lead to certain maladies. In particular, electrostatic charge build-up may adversely affect the nervous system, causing muscle stiffness and back pain. In this physiologically stressed state, blood pressure rises, heart rate increases, and the digestive process slows. It is believed that the unnatural presence of electrostatic charges on the body may also have a correlation with certain diseases.

This stored charge arises from the fact that people now wear insulating shoes and live in environments that hold the body in free space above the earth. As such, humans no longer make frequent contact with the earth. Consequently, several solutions have been proposed to address human grounding, including those disclosed in U.S. Pat. Nos. 6,683,779; 7,212,392 and Application Publication No. U.S. 2006/0285266, the entire content of each being incorporated herein by reference.

### SUMMARY OF THE INVENTION

This invention resides in apparatus for electrically grounding users of saunas, particularly users of infrared saunas. It is believed that the combination of infrared energy and electrical grounding may prove more beneficial when used at the same as opposed to during separate sessions; that is, the IR sauna may be more effective in toxin flushing when the body is grounded.

Therapeutic apparatus according to the invention includes a sauna in combination with an electrical conductor having a first end connected to an electrical ground and a second end coupled to a person using the sauna for the purpose of intentionally grounding the user. The sauna may include a plurality of infrared heaters, which may operate in the far-infrared, or at least one convection heater.

The second end of the electrical conductor may be coupled to a user through an electrically conductive body-worn strap, an electrically conductive pad or seat, or an electrically conductive bag enclosing at least a portion of a user's body.

### BRIEF DESCRIPTION OF THE DRAWINGS

FIG. 1 is a drawing that shows a user of a convention sauna;

FIG. 2 is a drawing that shows a user of an infrared sauna;

FIG. 3A is a drawing that shows an electrical ground may be obtained from an electrical wiring system;

FIG. 3B is a drawing that shows an electrical ground may alternatively be obtained from an earth ground;

FIG. 4 is a drawing that shows how a sauna user may be grounded with an electrically conductive wrist strap;

FIG. 5 is a drawing that illustrates how a sauna user may be grounded with an electrically conductive ankle strap;

FIG. 6 is a drawing that shows how a sauna user may be grounded with an electrically conductive pad for laying upon or sitting; and

FIG. 7 is a drawing that shows how the user of a bag-type sauna may be grounded according to the invention.

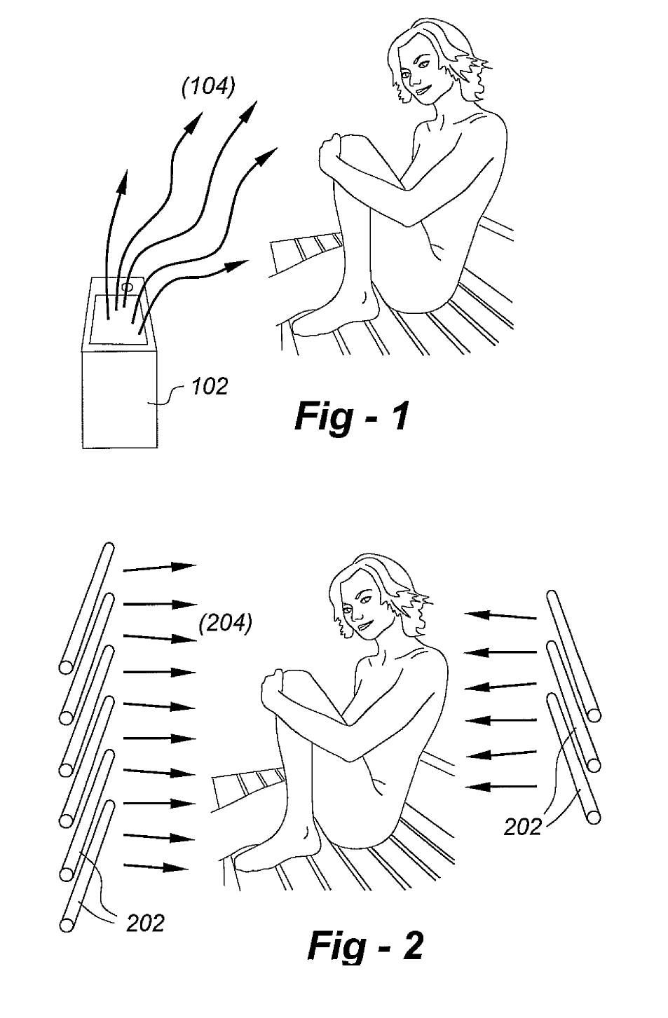

### DETAILED DESCRIPTION OF THE INVENTION

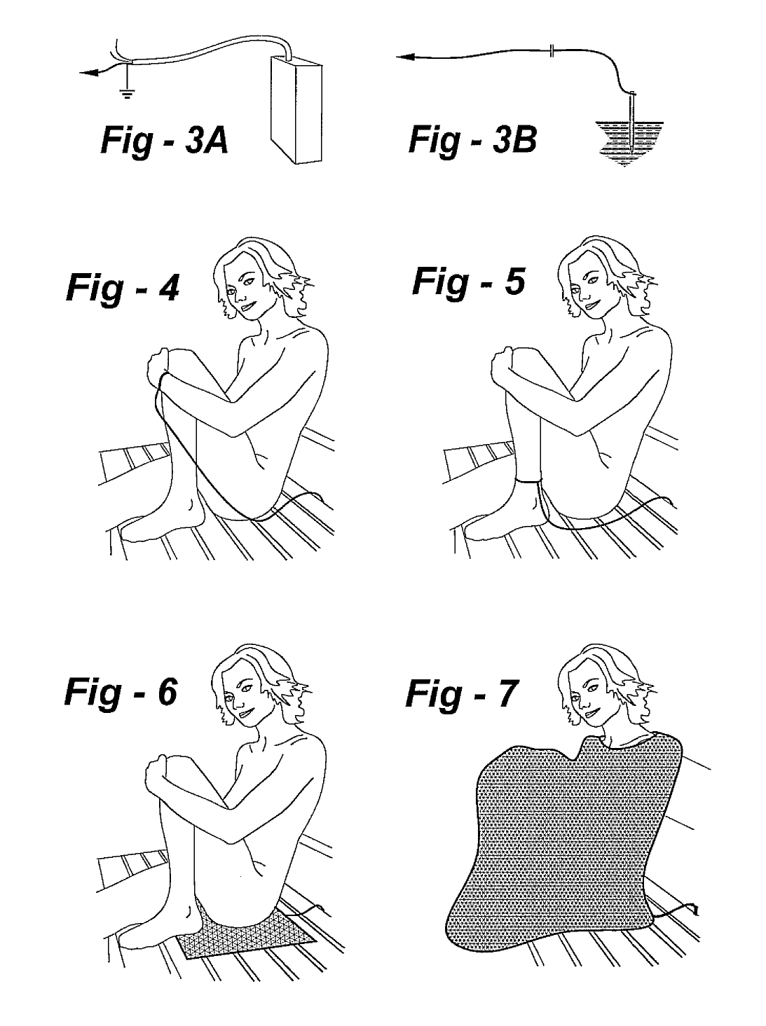

This invention relates generally to saunas and, in particular, to apparatus for electrically grounding users of saunas, particularly users of infrared saunas. Such grounding may be acquired in at least one of two ways. Since an electrical sauna is already connected to the AC line, the ground associated with the power line may conveniently be used, as shown in FIG. 3A. Alternatively a dedicated ground stake or strap may be used, as depicted in FIG. 3B.

The grounding of the user may be accomplished in any number of ways, alone or in combination. For example, the connection may be made via a wire or wires from the sauna ground to the user, terminating in a conductive strap for the wrist (FIG. 4), ankle (FIG. 5) or other portion of the body. A conductive surface such as a mesh or mat may be provided to sit or lay, or a conductive cloth or towel may be used, as shown in FIG. 6. If the sauna is of the flexible bag design, the bag itself may be electrically grounded, as illustrated in FIG. 7,

I claim:

1. Therapeutic apparatus, comprising:
a sauna; and
an electrical conductor having a first end connected to an electrical ground and a second end coupled to a person using the sauna for the purpose of intentionally grounding the user.

2. The therapeutic apparatus of claim 1, wherein the sauna includes a plurality of infrared heaters.

3. The therapeutic apparatus of claim 1, wherein the sauna includes a plurality of infrared heaters radiating energy in the far-infrared.

4. The therapeutic apparatus of claim 1, wherein the sauna includes a convection heater.

5. The therapeutic apparatus of claim 1, wherein the second end of the electrical conductor is coupled to a person through an electrically conductive body-worn strap.

6. The therapeutic apparatus of claim 1, wherein the second end of the electrical conductor is coupled to a person through an electrically conductive pad or seat.

7. The therapeutic apparatus of claim 1, wherein the second end of the electrical conductor is coupled to a person through an electrically conductive bag enclosing at least a portion of a user's body.
